(19) United States
(12) Patent Application Publication
(10) Pub. No.: US 2012/0185802 A1
(43) Pub. Date: Jul. 19, 2012

(54) METHOD AND APPARATUS FOR RETRIEVING AND DISPLAYING INFORMATION

(76) Inventor: Yisia Young Suk Lee, London (GB)

(21) Appl. No.: 13/008,665

(22) Filed: Jan. 18, 2011

(51) Int. Cl. G06F 3/048

(52) U.S. Cl. 715/841; 715/810

(57) ABSTRACT

Apparatus for displaying information, the apparatus comprising a status recording means for recording a status of at least one selected menu item, a user input device for receiving user selections, a controller configured to control a display device to display selectable menu items in a first display region, each of said selectable menu items having a status that can be switched between an active state and an inactive state, and wherein said selectable menu items correspond to information available in an information store, to retrieve information in response to a first selection of one of said selectable menu items, said retrieved information corresponds to the currently selected menu item, to control said display device to display said retrieved information in a second display region, switch said status of the currently selected menu item to a first active state, and control said status recording means to record said status of the currently selected menu item as said first active state, to control said display device to display a submenu of said selected menu item in said second display region in response to receiving a second selection of said selected menu item, switch said status of the currently selected menu item to a second active state, and control said status recording means to record said status of the currently selected menu item as said second active state, wherein said user input device is configured to receive a third selection of one of said selectable menu items, and said controller is configured to control said display device to display a submenu or information in response to said third selection in dependence upon said status of a previously selected menu item.

### BACKGROUND OF THE INVENTION

1. Field of the Invention

The present invention relates to an apparatus and a method for retrieving and displaying information from an information source.

2. Background of the Invention

It is desirable to make it easy for a user to retrieve and display information from an information source.

### BRIEF SUMMARY OF THE INVENTION

A first aspect of the present invention provides a method of displaying information, the method comprising displaying selectable menu items in a first display region, wherein each of said selectable menu items has a status that can be switched between an active state and an inactive state, said selectable menu items correspond to information available in an information source, and the status of at least a selected menu item is recordable, in response to receiving a first selection of one of said selectable menu items, retrieving information corresponding to the currently selected menu item, and recording said status of the currently selected menu item as a first active state, displaying the retrieved information in a second display region, in response to receiving a second selection of said selected menu item, displaying a submenu of said selected menu item in said second display region, and recording said status of the currently selected menu item as a second active state, and receiving a third selection of one of said selectable menu items, wherein a submenu or information is displayed in response to said third selection in dependence upon said status of a previously selected menu item.

Thus the present invention provides a method of performing at least two different types of actions (in this case, displaying information and displaying a submenu) in response to receiving a user selection of a menu item. Therefore, the method of the present invention allows a reduced number of selection buttons to be implemented in a user interface. This is advantageous as the required space for implementing the user interface can be significantly reduced, thereby providing a compact interface for retrieving and displaying information. This is particularly useful for application in a hand held device.

In one embodiment of the invention, the method may further comprise removing said submenu from said second display region, if said third selection is made of said previously selected menu item and said status of said previously selected menu item is said second active state.

In another embodiment of the invention, the method may further comprise displaying a submenu of the currently selected menu item in said second display region, if said third selection is made of an inactive selectable menu item and said status of said previously selected menu item is said second active state.

The method may further comprise removing said submenu of the previously selected menu item from said second display area.

In some embodiments, the method may further comprise receiving a selection of a submenu item of said submenu, and in response to said selection of the submenu item displaying information corresponding to said selected submenu item in said second display region.

The method may further comprise removing said submenu from said second display region, and displaying a further selectable menu item in said first display area, wherein said further selectable menu item corresponds to said displayed information.

Therefore, the present invention allows a display region of a display to be used for displaying information and a submenu. This provides the advantage of efficient use of the display region. Furthermore, the present invention provides separate display regions to display information and menu items, thereby allowing rapid and easy navigation through the information structure, whilst simultaneously displaying the selected information.

The method may further comprise recording said status of said further selectable menu item as said first active state.

The step of displaying selectable menu items includes displaying history menu items relating to previously received user selections of said selectable menu items and the currently selected menu item in said first display region. This provides an advantage of allowing the user to easily navigate to a previously selected menu items.

The previously received user selections of said selectable menu items correspond to navigation down levels of a hierarchy of the information.

The step of displaying selectable menu items includes replacing at least one of said selectable menu items with the currently selected menu item. This allows a reduced number of menu items to be displayed, thereby providing an efficient use of display region.

The first selection, second selection, third selection, and the selection of the submenu item are of the same selection type.

In a second aspect of the invention, there is provided a method of displaying information, the method comprising displaying selectable menu items in a first display region, wherein said selectable menu items correspond to information available in an information source, in response to receiving a first selection of one of said selectable menu items, retrieving information corresponding to the currently selected menu item, displaying the retrieved information in a second display region, and in response to receiving a second selection of said selected menu item, displaying a submenu of said selected menu item in said second display region, wherein said first selection and said second selection are of the same selection type.

Menu items may be selected using a pointer displayed on the display, for example, a pointer linked to a mouse or other input device. In this case the type of selection may include rolling the pointer of the mouse over a menu item or clicking of a pointer on a menu item (left and right mouse click being different types of selections). Alternatively, menu items may be selected without a pointer being displayed on the screen, e.g. by use of a touch sensitive screen, and touching the part of the screen corresponding to the menu item. In this case, the menus may be activated and items selected by a touching the position of the menu item to be selected on the touch sensitive screen. Only one type of touching operation is required, e.g. a single tap on the screen or a double tap on the screen.

The menu items may also be selected by detecting the user's motion relative to the menu item on the display screen. This can be implemented using a detector to detect movements of the user, and to select the desired menu item based on the detected movement. The menu items may be selected by gestures or simply the position or shape of a part or the whole body of a user. Whatever type of operation causes a selection of a menu is used as same for the first and second selection (and for subsequent selection of a menu item).

Thus the present invention provides a method of performing at least two different types of actions (in this case, displaying information and displaying a submenu) in response to receiving a user selection of a menu item using only one type of selection. This is advantageous because it simplifies the way a user makes a selection on a display, and it allows a reduced number of functions to be assigned to a user input device.

In an embodiment, the method may further comprise removing said submenu from said second display region, in response to receiving a third selection of said selected menu item.

In another embodiment, the method may further comprise receiving a third selection of an unselected menu item, and in response to said third selection, displaying a submenu of the currently selected menu item in said second display region.

The method may further comprise removing said submenu of the previously selected menu item from said second display area.

In some embodiments, the method may further comprise receiving a selection of a submenu item of said submenu, and in response to said selection of the submenu item displaying information corresponding to said selected submenu item in said second display region.

The method may further comprise removing said submenu from said second display region, and displaying a further selectable menu item in said first display area, wherein said further selectable menu item corresponds to said displayed information.

In one embodiment, the step of displaying selectable menu items includes displaying history menu items relating to previously received user selections of said selectable menu items and the currently selected menu item in said first display region.

The previously received user selections of said selectable menu items correspond to navigation down levels of a hierarchy of the information.

The step of displaying selectable menu items includes replacing at least one of said selectable menu items with the currently selected menu item.

The first selection, second selection, third selection, and the selection of the submenu item are of the same selection type.

A third aspect of the invention provides an apparatus for displaying information, the apparatus comprising a status recording means for recording a status of at least one selected menu item, a user input device for receiving user selections, a controller configured to control a display device to display selectable menu items in a first display region, each of said selectable menu items having a status that can be switched between an active state and an inactive state, and wherein said selectable menu items correspond to information available in an information store, to retrieve information in response to a first selection of one of said selectable menu items, said retrieved information corresponds to the currently selected menu item, to control said display device to display said retrieved information in a second display region, switch said status of the currently selected menu item to a first active state, and control said status recording means to record said status of the currently selected menu item as said first active state, to control said display device to display a submenu of said selected menu item in said second display region in response to receiving a second selection of said selected menu item, switch said status of the currently selected menu item to a second active state, and control said status recording means to record said status of the currently selected menu item as said second active state, wherein said user input device is configured to receive a third selection of one of said selectable menu items, and said controller is configured to control said display device to display a submenu or information in response to said third selection in dependence upon said status of a previously selected menu item.

In one embodiment, the controller may be further configured to remove said submenu from said second display region, if said third selection is made on said previously selected menu item and said status of said previously selected menu item is said second active state.

In another embodiment, the controller may be further configured to control said display device to display a submenu of the currently selected menu item, if said third selection is made on an inactive selectable menu item and said status of said previously selected menu item is said second active state.

The controller may be configured to control said display device to remove said submenu of the previously selected menu item from said second display area.

In some embodiments, the user input device may be configured to receive a selection of a submenu item of said submenu, and in response to said selection of said submenu item said controller is configured to control said display device to display information corresponding to said selected submenu item in said second display region.

The controller may be configured to control said display device to remove said submenu from said second display region, and to display a further selectable menu item in said first display area, wherein said further selectable menu item corresponds to said displayed information.

The controller may be configured to control said status recording means to record said status of said further selectable menu item as said first active state.

In one embodiment, the controller may be configured to control said display device to display selectable menu items including history menu items relating to previously received user selections of said selectable menu items and the currently selected menu item in said first display region.

The previously received user selections of said selectable menu items correspond to navigation down levels of a hierarchy of the information.

In another embodiment, the controller may be configured to control said display device to replace at least one of said selectable menu items with the currently selected menu item.

The first selection, second selection, third selection, and the selection of the submenu item are of the same selection type.

In a fourth aspect of the invention there is provided an apparatus for displaying information, the apparatus comprising a user input device for receiving user selections, a controller configured to control a display device to display selectable menu items in a first display region, wherein said selectable menu items correspond to information available in an information store, to retrieve information in response to a first selection of one of said selectable menu items, said retrieved information corresponds to the currently selected menu item, to control said display device to display said retrieved information in a second display region, and to control said display device to display a submenu of said selected menu item in said second display region, in response to receiving a second selection of said selected menu item, wherein said first selection and said second selection are of the same selection type.

In one embodiment, the user selection device may be configured to receive a third selection of said selected menu item, and in response to said third selection, said controller is configured to control said display device to remove said submenu from said second display region.

In another embodiment, the user selection device may be configured to receive a third selection of an unselected menu item, and in response to said third selection, said controller is configured to control said display device to display a submenu of the currently selected menu item in said second display region.

The controller may be configured to control said display device to remove said submenu of the previously selected menu item from said second display area.

In some embodiments, the user input device may be configured to receive a selection of a submenu item of said submenu, and in response to said selection of the submenu item, said controller is configured to control said display device to display information corresponding to said selected submenu item in said second display region.

The controller may be configured to control said display device to remove said submenu from said second display region, and to display further selectable menu item in said first display region, wherein said further selectable menu item corresponds to said displayed information.

In one embodiment, the controller may be configured control said display device to display selectable menu items including history menu items relating to previously received user selections of said selectable menu items and the currently selected menu item in said first display region.

The previously received user selections of said selectable menu items correspond to navigation down levels of a hierarchy of the information.

The controller is configured to control said display device to replace at least one of said selectable menu items with the currently selected menu item.

The first selection, second selection, third selection, and the selection of the submenu item are of the same selection type.

The present invention can be implemented by software or programmable computing apparatus. Thus the present invention encompasses a storage medium storing computer readable code for configuring a computer or number of computers as the apparatus of the invention. The storage medium can comprise a floppy disk, CD ROM, hard disk, or programmable memory device for example.

### BRIEF DESCRIPTION OF THE DRAWINGS

Embodiments of the invention will now be described by way of example only, with reference to the accompanying drawings, in which:

FIG. 1 is a block diagram showing an apparatus according to an embodiment of the invention;

FIG. 2a is a screen layout showing the layout of information on a display used in embodiments of the invention;

FIG. 2b is the screen layout of FIG. 2a illustrating the layout of a plurality of menu items and a dropdown menu according to embodiments of the invention;

FIG. 2c is the screen layout of FIG. 2a illustrating contents of a menu item according to an embodiment of the invention;

FIG. 2d is the screen layout of FIG. 2a illustrating a projected image or hologram image according to an embodiment of the invention;

FIG. 3a shows a plurality of screen layouts when a user navigates through an information source and the arrows indicate the way in which these screen layouts are interlinked;

FIGS. 3b to 3d each shows the change in the screen layout of FIGS. 2a and 2b when a menu item is selected according to embodiments of the invention;

FIG. 4 illustrates a plurality of screen layouts of FIGS. 2a and 2b when a menu item is selected according to an embodiment of the invention;

FIG. 5 shows a plurality of screen layouts for different selections made on the screen layout of FIGS. 2a and 2b, and the arrows indicate the way in which these screen layouts are interlinked;

FIG. 6 is a flow chart showing a process for retrieving and displaying information according to embodiments of the invention; and

FIGS. 7a to 7c each shows the change in the screen layout of FIG. 2a when a submenu item of a submenu is selected according to embodiments of the invention;

### DETAILED DESCRIPTION OF EMBODIMENTS OF THE INVENTION

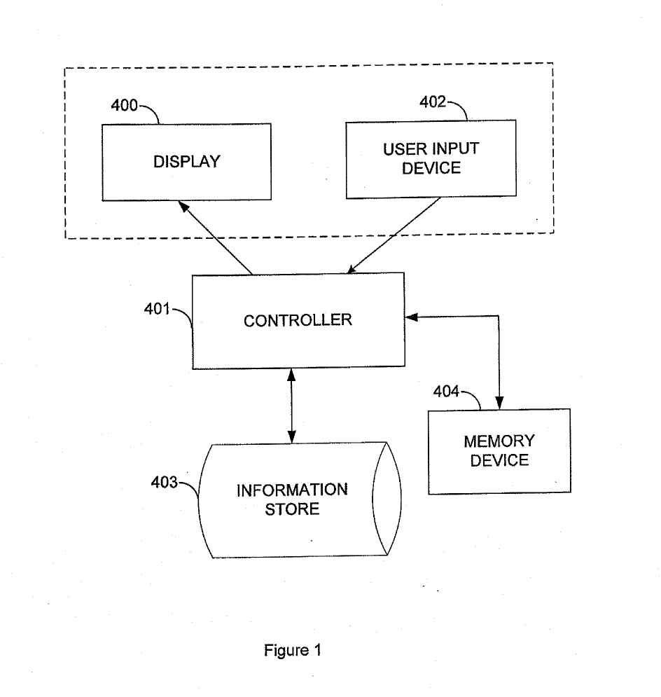

FIG. 1 is a block diagram showing an apparatus according to an embodiment of the invention. The apparatus has a display 400, a controller 401, a user interface 402, an information store 403, and a memory device 404. The display 400 and the user input device 402 are both connected to the controller 401, such that information passes from the controller 401 to the display 400, and from the user input device 402 to the controller 401. The user input device 402 may be integral with the display 400, or may be separate, as indicated by the dashed line surrounding both the display 400 and the user input device 402. The information store 403 is connected to the controller 401 to allow information requests to pass from the controller 401 to the information store 403, and information to pass from the information store 403 to the controller 401, for subsequent display on the display 400. The information store 403 may not be part of the apparatus and in this case the apparatus includes an interface (not shown) for accessing the information store. The interface can comprise a port or connector to allow the apparatus to be connected in a computer apparatus to access the information store, or the interface can comprise a network interface. The memory device 404 is connected to the controller 401 to allow status information, such a status of a selected menu item, to be recorded and stored, and status information to be retrieved from the memory device 404 to the controller 401 when required.

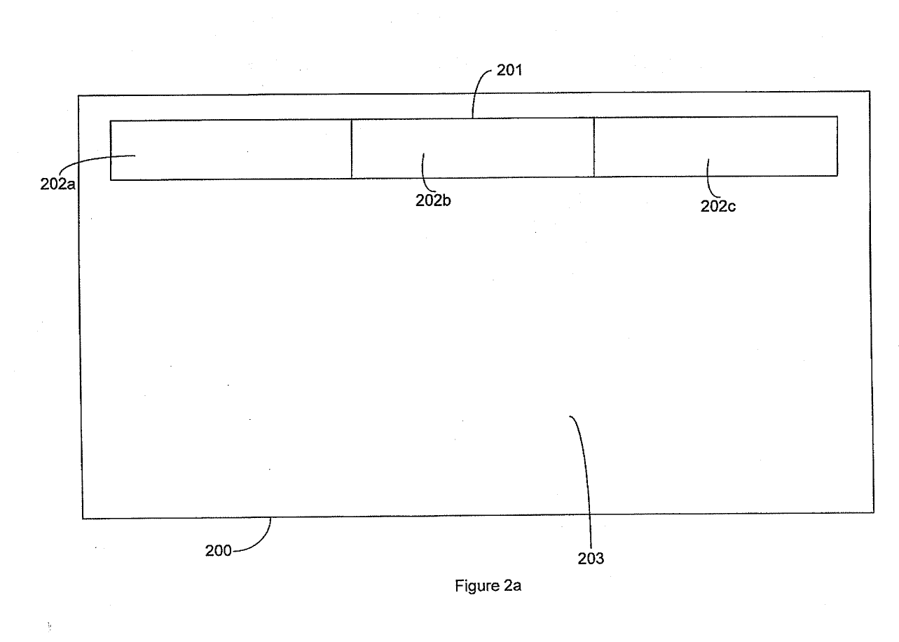

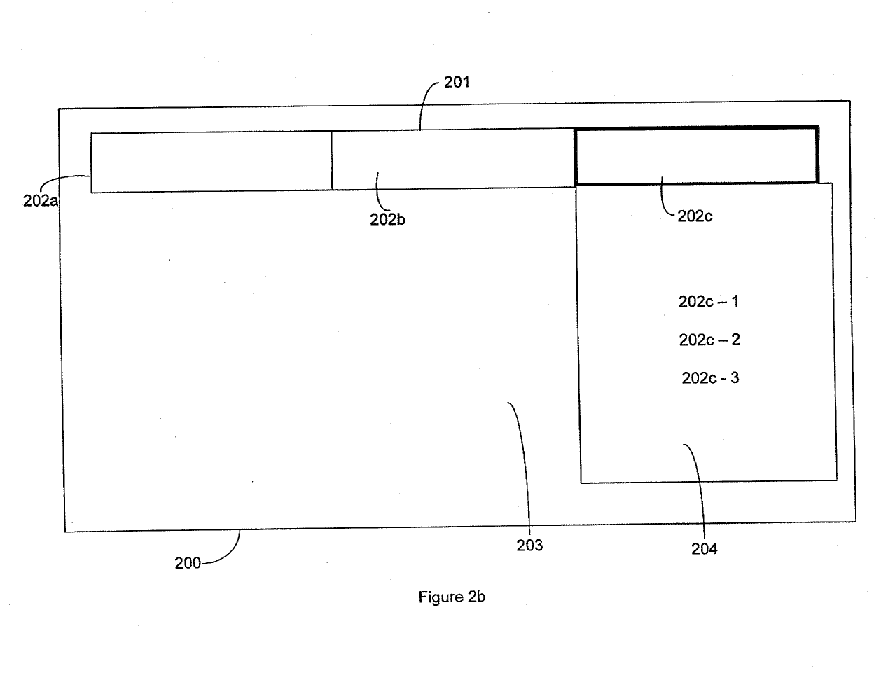

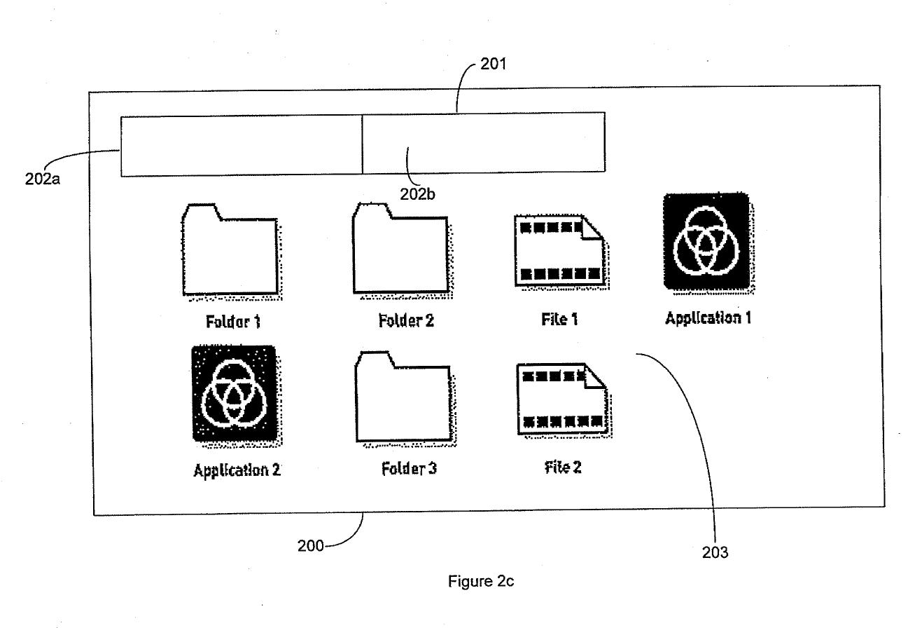

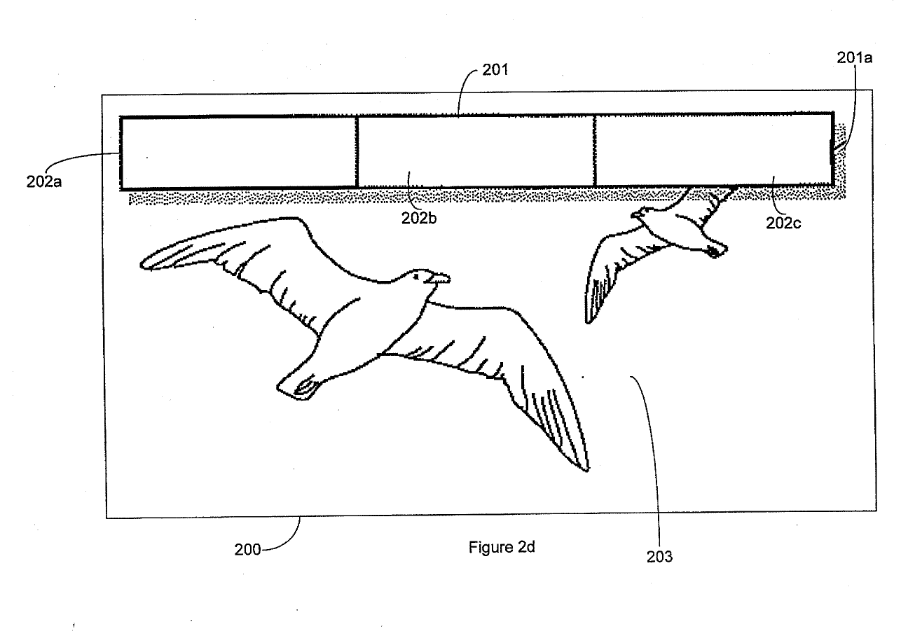

FIG. 2a illustrates a screen layout for a display screen 200 in an embodiment of the invention. The screen 200 is divided into an upper section 201 and a lower section 203. The lower section 203 of the screen is used for displaying information to the user. The information displayed in the lower section 203 may include content(s) of a folder or a content of a file. Examples of the information displayed will be discussed in more detail in the forthcoming paragraphs.

The upper section 201 is reserved for displaying menu items 202a, 202b, 202c to allow a user to navigate to a location in an information structure in the information store. Each item in the upper section is located in a separate box or in a space within the upper section 201 of the screen 200. It will be appreciated that the number of menu items is not limited to three menu items, as illustrated in this example. In particular, the number of menu items is not limited by the space of the display screen. For example, as the number of menu items increases, the size of each menu item may be reduced such that all the menu items fit within the available space of the display screen 200.

Alternatively, a scroll feature can be included in the upper section 201 to allow the user to scroll through the available menu items.

In one embodiment of the invention, the upper section 201 can be reserved for displaying a history list to allow a user to navigate back to a location which they have previously visited.

In another embodiment of the invention, the upper section 201 can be reserved for displaying a history list to allow a user to navigate back upwards in a hierarchy of the information structure to a location which they have previously visited.

FIG. 2b shows a screenshot using the screen layout of FIG. 2a with an example of a drop-down menu 204 displayed in the lower section 203 of the screen 200. In FIG. 2b, the upper section 201 is similar to that in FIG. 2a. However, the border of the menu item 202c has been highlighted to indicate that it is the currently selected menu item. The drop-down menu 204 is displayed in the lower section 203 of the screen 200. The drop-down menu 204 shows a list of items 202c-1, 202c-2, 202c-3 which are available within the menu item 202c. The submenu items 202c-1, 202c-2, 202c-3 may include files, file folders, and/or links to local files or remote files. Any one of the submenu items may be removed or more submenu items may be added if desired.

In another embodiment of the invention, the menu items 202a, 202b, and 202c in the upper section 201 may not be related to each other. In this configuration, the upper section 201 is neither a history list nor a hierarchical history list. For example, the menu item 202a may be configured as a favourite websites item for displaying a list of the user's favourite website links in its drop-down menu (not shown), the menu item 202b may be configured as a personal contact item for displaying a list of contact telephone numbers in its drop-down menu (not shown), and the menu item 202c may be configured to display a mobile device network configuration and display setting list in its drop-down menu. In such a configuration, the positions of the menu items 202a, 202b, and 202c may also be rearranged. For example, the menu items may be rearranged to display in the upper section 201 (from left to right) in the following order 202c, 202b, and 202a. Furthermore, the menu items may removed or replaced by another menu item, or additional menu items may also be added.

FIG. 2c shows a screenshot using the screen layout of FIG. 2a. The menu items 202a, 202b, are located in the upper section 201 of the screen 200. The lower section 203 shows icons representing different items including a folder labelled “Folder 1”, a folder labelled “Folder 2”, a file labelled “File 1”, an application labelled “Application 1”, an application labelled “Application 2”, a folder labelled “Folder 3”, and a file labelled “File 2”. The example illustrated in this figure demonstrates that the contents of a menu item, 202a or 202b, can include files and file folders.

FIG. 2d shows a screenshot using the screen layout of FIG. 2a. Similarly, the menu items 202a, 202b, 202c are located in the upper section 201 of the screen 200. The lower section 203 of the screen 200, in this example shows an image being displayed in the lower section 203. FIG. 2d shows two images of a seagull. The shadow 201a below the menu items illustrates that the display screen is a projected image on a screen or a wall surface.

The display screen 200, in accordance with the embodiments of the invention, is not limited to a computer screen display. The screen display 200 of the present invention also includes a screen of a handheld computer device, including devices such as PDAs (personal digital assistance), electronic book readers, mobile phones, digital audio players, GPS (global positioning satellite) receivers, etc. Such devices have relatively small screens, and the present invention provides the considerably advantage of allowing very efficient use of the limited display area available on the screen. The display screen, according to the embodiments of the invention, also includes a touch-sensitive screen, which may be activated using a variety of methods such as by a person's finger or using a stylus. Furthermore, the display screen of the present invention may also include a projected display such as a projected image on a screen or a wall surface from an image projecting device. The screen display of the present invention may also include a three-dimensional holographic image projected using a hologram device. The holographic image projected into the air allows a user to select the menu items by detecting the movement of the user relative to the projected holographic image of the menu items.

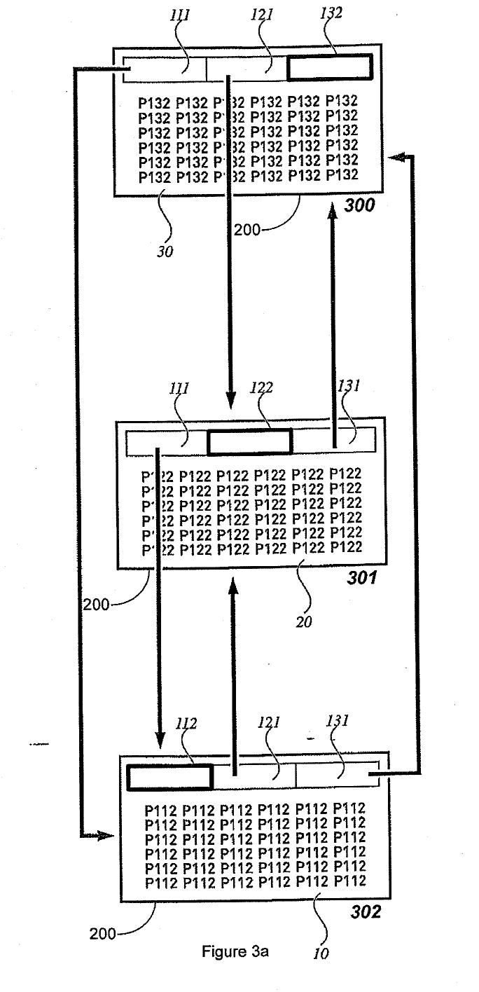

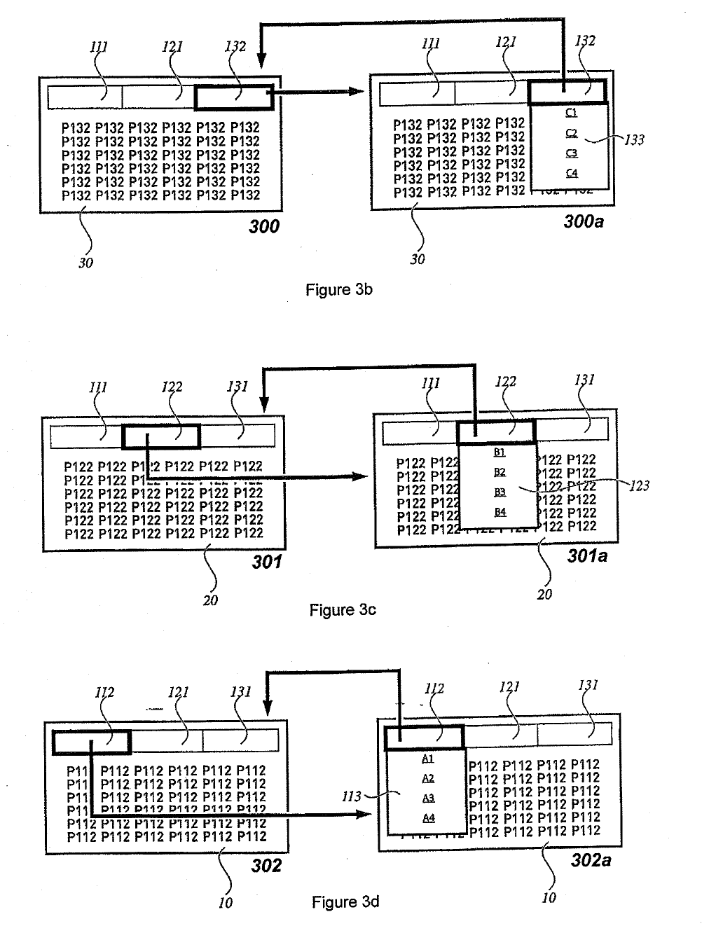

FIG. 3a shows a number of screen layouts 300, 301, 302 which demonstrate different stages of navigation through different locations of the information store in an embodiment of the invention. Arrows are shown connecting the screen layouts to illustrate how to move from one screen layout to another by selecting a menu item in the upper section of the display screen, The lower section of the screen displays information corresponding to the selected menu item. As shown in this figure, the border of the selected menu item is enhanced to distinguish it from the unselected menu items. The enhanced border of the selected menu item also indicates that the currently selected menu item is in an active state. Accordingly, the memory device 404 records the status of the selected menu item as “active-1”.

The screenshot 300 in FIG. 3a illustrates that the menu item 132 has been selected and the lower section 30 of the screen displays the information corresponding to the selected menu item 132.

If a user selects the menu item 121 in the upper section of the screen, the screen is updated with the screenshot 301. In this screenshot, the menu item 121 has been relabelled as 122 to indicate that it is currently the selected menu item. The border of the menu item 122 is also highlighted to indicate that this menu item is in its active state. The memory device 404 records the status of the currently selected menu item 122 as “active-1”. Accordingly, the status of the menu item 131 is now recorded as “inactive”. The lower section 20 of the display screen 200 is also updated with contents and information corresponding to the selected menu item 122.

If a user selects the menu item 111 in the upper section of the screen, the screen is updated with the screenshot 302. In this screenshot, the menu item 111 has been relabelled as 112 to indicate that it is currently the selected menu item. The border of the menu item 112 is also highlighted to indicate that this menu item is in its active state. The memory device 404 records the status of the currently selected menu item 112 as “active-1”. Accordingly, the status of the menu item 121 is now recorded as “inactive”. The lower section 10 of the display screen 200 is also updated with contents and information corresponding to the selected menu item 112.

Referring to the screenshots 301 and 302, if a user selects the menu item 131 in the upper section of the screen, the screen is updated with the screenshot 300. In this screenshot, the menu item 131 has been relabelled as 132 to indicate that it is currently the selected menu item. The border of the menu item 132 is also highlighted to indicate that this menu item is in its active state. The memory device 404 records the status of the currently selected menu item 132 as “active-1”. Accordingly, the status of the menu items 111 and 121 are now recorded as “inactive”. The lower section 30 of the display screen 200 is also updated with contents and information corresponding to the selected menu item 132.

FIG. 3b shows the screenshots 300 and 300a. The screenshot 300 in this figure is identical to the screenshot 300 shown in FIG. 3a. Arrows are shown connecting the screenshots to illustrate how to move from one screen layout to another by selecting the selected menu item 132 in the upper section of the display screen. As discussed in the preceding paragraphs, the status of the selected menu item 132 in screenshot 300 is recorded as “active-1”. If the user selects the currently selected menu item 132, the screen layout is updated with the screenshot 300a.

The screenshot of 300a illustrates a drop-down menu 133 is displayed in the lower section 30 of the screen. The drop-down menu shows a list of submenu items C1, C2, C3, and C4 available within the menu item 132. The submenu items C1, C2, C3, and C4 may include files, file folders, and/or links to local files or remote files. When the drop-down menu is displayed, all of the information previously displayed in the lower section 30 may be deleted, or the information may simply be overwritten in the part of the lower section 30 of the screen which is used to display the drop-down menu 133.

In the screenshot of 300a, the currently selected menu item 132 is highlighted to indicate that it is in an active state. The memory device 404 records the status of the selected menu item 132 as “active-2”.

Thus, in this example the memory device records two types of active status, namely:

“active-1” when a menu item is selected, and “active-2” when a selected menu item is subsequently selected. Although, two types of active status are described as being recordable by the memory device 404, it will be appreciated that it is not so limited. For example, the memory device 404 can be configured to record more that two types of active status depending on the application. The memory device 404 can also be configured to record status of menu items that have not been selected.

When the user selects the currently selected menu item 132 in its “active-2” state, the drop-down menu 133 disappears, and the screen layout returns to the screenshot 300. Accordingly, the memory device 404 records the status of the selected menu item 132 to “active-1”.

FIG. 3c shows the screenshots 301 and 301a. The screenshot 301 in this figure is identical to the screenshot 301 shown in FIG. 3a. Arrows are shown connecting the screenshots to illustrate how to move from one screen layout to another by selecting the selected menu item 122 in the upper section of the display screen. The status of the selected menu item 122 in screenshot 301 is recorded as “active-1”. If the user selects the currently selected menu item 122, the screen layout is updated with the screenshot 301a.

The screenshot of 301a illustrates a drop-down menu 123 is displayed in the lower section 20 of the screen. The drop-down menu 123 shows a list of submenu items B1, 82, B3, and B4 available within the menu item 122. The submenu items B1, B2, B3, and B4 may include files, file folders, and/or links to local files or remote files. When the drop-down menu is displayed, all of the information previously displayed in the lower section 20 may be deleted, or the information may simply be overwritten in the part of the lower section 20 of the screen which is used to display the drop-down menu 123. In the screenshot of 301a, the currently selected menu item 122 is highlighted to indicate that it is in an active state. The memory device 404 records the status of the selected menu item 122 as “active-2”.

When the user selects the currently selected menu item 122 in its “active-2” state, the drop-down menu 123 disappears, and the screen layout returns to the screenshot 301. Accordingly, the memory device 404 records the status of the selected menu item 122 to “active-1”.

FIG. 3d shows the screenshots 302 and 302a. The screenshot 302 in this figure is identical to the screenshot 302 shown in FIG. 3a. Arrows are shown connecting the screenshots to illustrate how to move from one screen layout to another by selecting the selected menu item 112 in the upper section of the display screen. The status of the selected menu item 112 in screenshot 302 is recorded as “active-1”. If the user selects the currently selected menu item 112, the screen layout is updated with the screenshot 302a.

The screenshot of 302a illustrates a drop-down menu 123 is displayed in the lower section 10 of the screen. The drop-down menu 113 shows a list of submenu items A1, A2, A3, and A4 available within the menu item 112. The submenu items A1, A2, A3, and A4 may include files, file folders, and/or links to local files or remote files. When the drop-down menu is displayed, all of the information previously displayed in the lower section 10 may be deleted, or the information may simply be overwritten in the part of the lower section 10 of the screen which is used to display the drop-down menu 113. In the screenshot of 302a, the currently selected menu item 112 is highlighted to indicate that it is in an active state. The memory device 404 records the status of the selected menu item 112 as “active-2”.

When the user selects the currently selected menu item 112 in its “active-2” state, the drop-down menu 113 disappears, and the screen layout returns to the screenshot 302. Accordingly, the memory device 404 records the status of the selected menu item 112 to “active-1”.

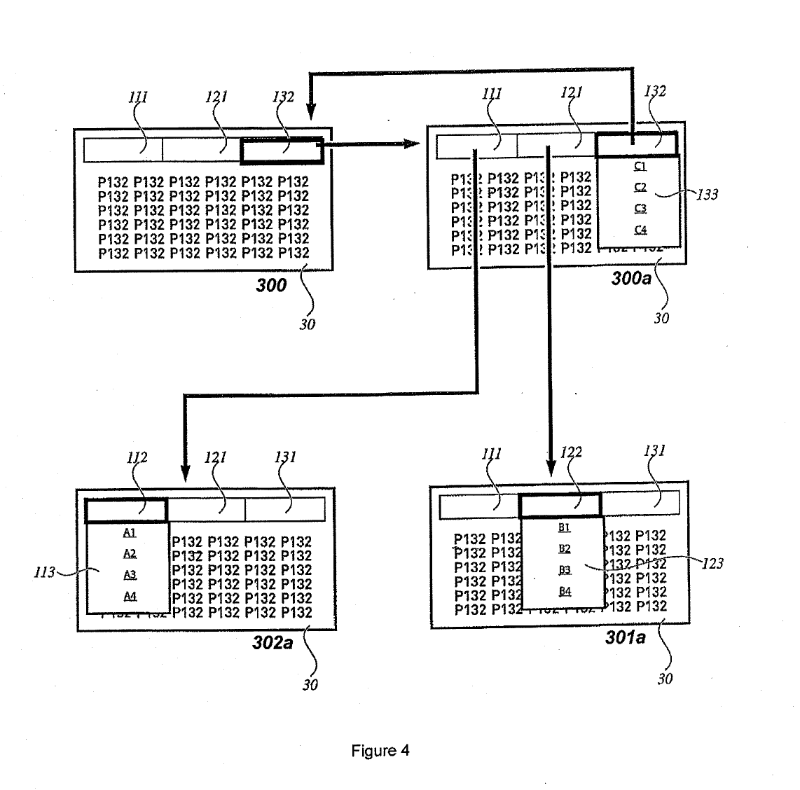

FIG. 4 shows the screenshots 300, 300a, 301a, and 302a. The screenshots 300, 300a, 301a, and 301b are identical to those shown in FIGS. 3b, 3c, and 3d. Again, arrows are shown connecting the screenshots to illustrate how to move from one screen to another by selecting the menu items 111, 121, and 132 in the upper section of the screen.

In this example, the process begins from the screenshot 300 on the top left hand side of FIG. 4. The selected menu item 132 is highlighted to indicate that it is the currently selected menu item and its status is recorded as “active-1”. As discussed in the previous example, two types of active status (“active-1” and “active-2”) for the selected menu item can be recorded by the memory device 404.

If the user selects the selected menu item 132, the screen layout is updated with the screenshot 300a. The screenshot of 300a illustrates a drop-down menu 133 is displayed in the lower section 30 of the screen. The drop-down menu shows a list of submenu items C1, C2, C3, and C4 available within the menu item 132. The submenu items C1, C2, C3, and C4 may include files, file folders, and/or links to local files or remote files. When the drop-down menu is displayed, all of the information previously displayed in the lower section 30 may be deleted, or the information may simply be overwritten in the part of the lower section 30 of the screen which is used to display the drop-down menu 133. In the screenshot of 300a, the currently selected menu item 132 is highlighted to indicate that it is in an active state. The memory device 404 records the status of the selected menu item 132 as “active-2”.

On the screen layout of screenshot 300a, the user can (1) select menu item 111 to move to screenshot 302a, (2) select menu item 121 to move to screenshot 301a, or (3) selected the select menu item 132 to return to screenshot 300.

If the user selects the currently selected menu item 132 in its “active-2” state, the drop-down menu 133 disappears, and the screen layout returns to the screenshot 300. Accordingly, the memory device 404 records the status of the selected menu item 132 as “active-1”.

If the user selects the menu item 121, the screen layout is updated with the screenshot 301a. The screenshot of 301a illustrates a drop-down menu 123 is displayed in the lower section 30 of the screen. The drop-down menu 123 shows a list of submenu items B1, B2, B3, and B4 available within the selected menu item 122. The submenu items B1, B2, B3, and B4 may include files, file folders, and/or links to local files or remote files. When the drop-down menu is displayed, all of the information previously displayed in the lower section 30 may be deleted, or the information may simply be overwritten in the part of the lower section 30 of the screen which is used to display the drop-down menu 123.

In the screenshot of 301a, the currently selected menu item 122 is highlighted to indicate that it is in an active state. The memory device 404 records the status of the selected menu item 122 as “active-2”.

If the user selects the menu item 111, the screen layout is updated with the screenshot 302a. The screenshot of 302a illustrates a drop-down menu 113 is displayed in the lower section 30 of the screen. The drop-down menu 113 shows a list of submenu items A1, A2, A3, and A4 available within the selected menu item 112. The submenu items A1, A2, A3, and A4 may include files, file folders, and/or links to local files or remote files. When the drop-down menu is displayed, all of the information previously displayed in the lower section 30 may be deleted, or the information may simply be overwritten in the part of the lower section 30 of the screen which is used to display the drop-down menu 113.

In the screenshot of 302a, the currently selected menu item 112 is highlighted to indicate that it is in an active state. The memory device 404 records the status of the selected menu item 112 as “active-2”.

This example demonstrates that when one of the menu items is in an “active-2” status, the user can display the drop-down menu of other menu items without changing the information currently displayed in the lower section of the screen. Thus, the system does not have to retrieve further information relating to the subsequently selected menu item when the user only wants to view the submenu items available in each menu item. This provides a technical advantage of reducing the processing overhead of the system.

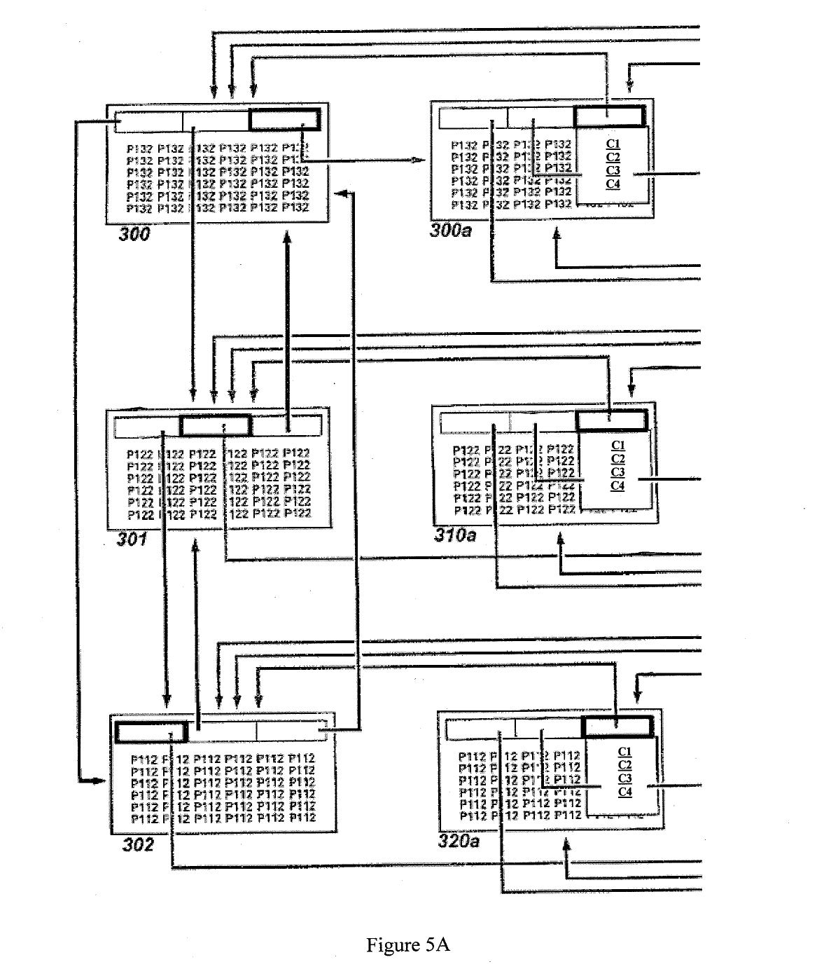

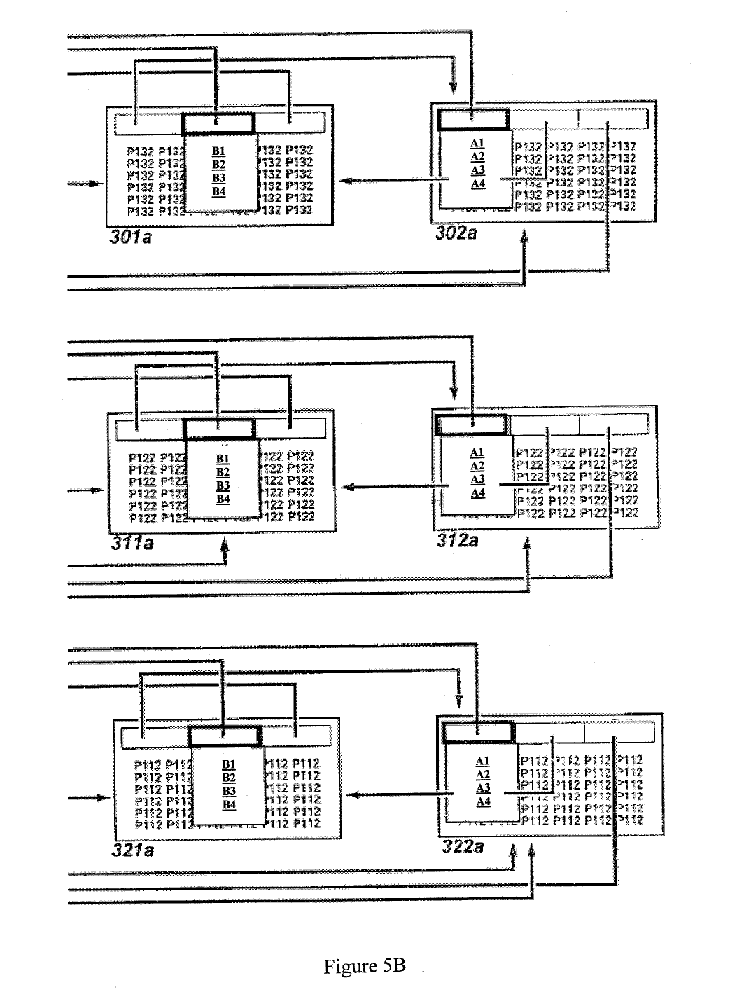

FIG. 5 is an alternative illustration of the examples described above with reference to FIGS. 3a, 3b, 3c, 3d, and 4.

FIG. 5 illustrates a number of screen layouts 300, 300a, 301a, 302a, 301, 310a, 311a, 312a, 302, 320a, 321a, 322a which show different stages of navigation through different locations of information store in an embodiment of the invention. Arrows are shown connecting the screen layouts to illustrate how to move from one screen layout to another by selecting a menu item in the upper section of the display screen,

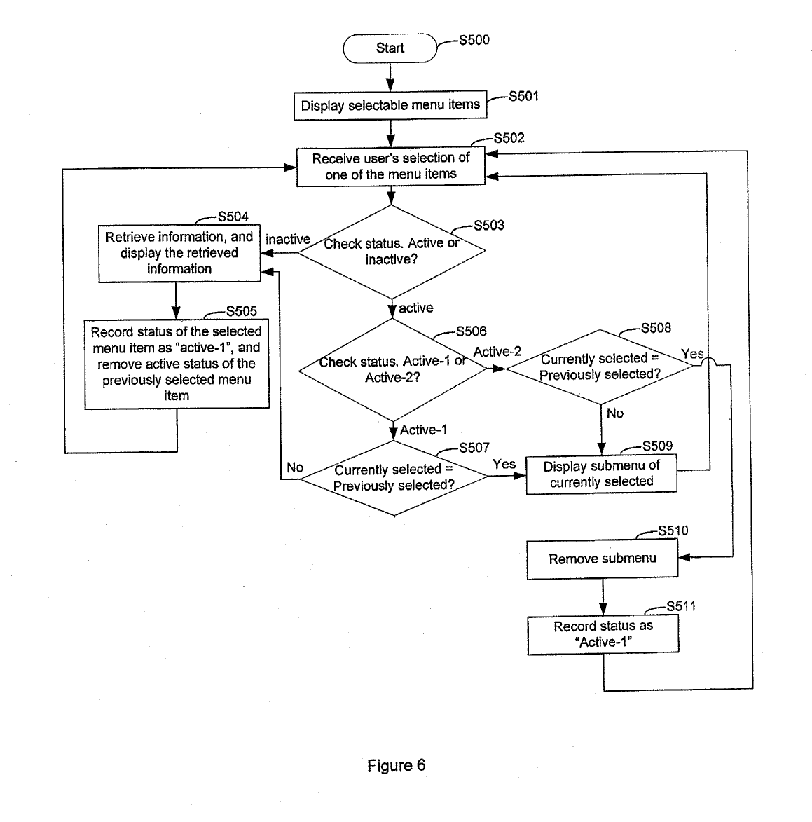

FIG. 6 shows a flowchart of the process of displaying information and a submenu of a menu item as described in the above examples.

The process begins at step S500. At step S501, the apparatus presents the user with a number of menu items in the upper section of the screen. At step S502, the apparatus receives a user selection of one of the menu items.

At step S503, the apparatus checks the status of the selected menu item. If the status of the currently selected menu item is inactive, the apparatus retrieves information relating to the selected menu item and displays the retrieved information in the lower section of screen (step S504). The apparatus also records the status of the selected menu item as “active-1” (step S505), and removes active status, if any, of a previously selected menu item. The process then returns to step S502 of the flowchart.

If the status of the currently selected menu item is active, the apparatus checks whether the status of the currently selected menu item is in “active-1” or “active-2” state (step S506).

If the status of the currently selected menu item is “active-1”, the apparatus checks whether the currently selected menu item is the same as the previously selected menu item (S507). If the status of the previously selected menu item is “active-1” and the currently selected menu item is different from the previously selected menu item, the apparatus retrieves information relating to the currently selected menu item and displays the retrieved information in the lower section of the screen (step S504). At step S505, the apparatus records the status of the selected menu item as “active-1” and removes the active status of the previously selected menu item.

If the status of the previously selected menu item is “active-1” and the currently selected menu item is the same as the previously selected menu item, the apparatus displays a submenu in the lower section of the display screen (step S509). The process then returns to step S502 of the flowchart.

If the status of the currently selected menu item is “active-2”, the apparatus checks whether the currently selected menu item is the same as the previously selected menu item (S508). If the status of the previously selected menu item is “active-2” and the currently selected menu item is different from the previously selected menu item, the apparatus displays a submenu in the lower section of the display screen (step S509). The process then returns to step S502 of the flowchart.

If the status of the previously selected menu item is “active-2” and the currently selected menu item is the same as the previously selected menu item, the apparatus removes the submenu from the lower section of the display screen (step S510). At step S511, the apparatus records the status of the currently selected menu item as “active-1”. The process then returns to step S502 of the flowchart.

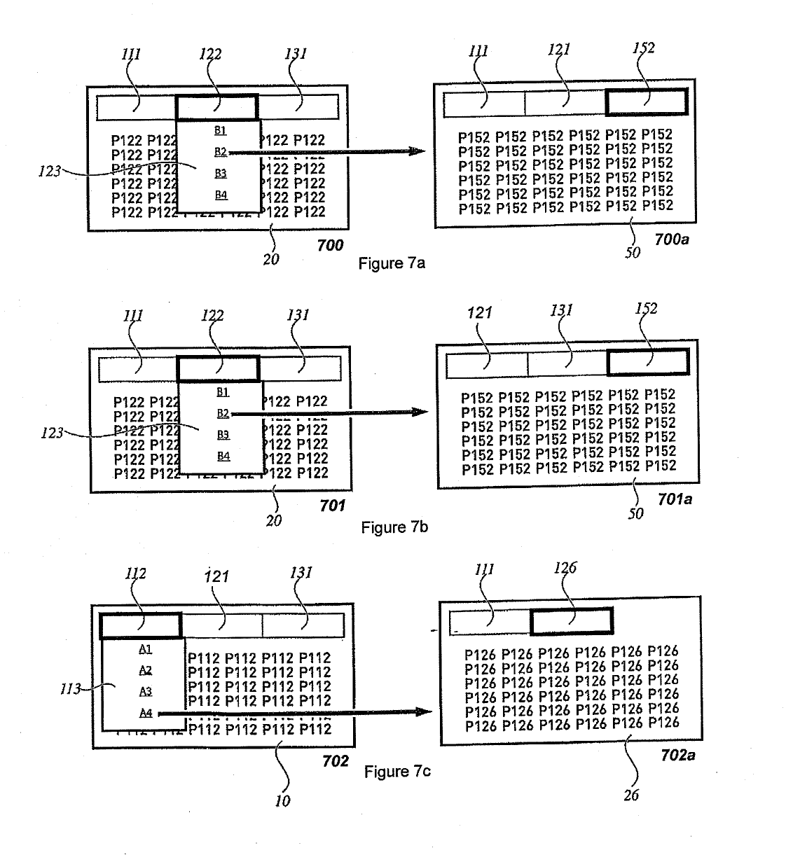

The screenshots of FIGS. 7a, 7b, and 7c illustrate different screen layouts when a submenu item is selected.

The example of FIG. 7a demonstrates that the apparatus of the invention can be configured to display the menu items as a history list containing the top level node (menu item 111), the selected second level node (selected menu item 122), and the third level node (menu item 131) of a hierarchical information structure.

In the screenshot of 700, the menu items 111, 122, 131 are located in the upper section of the screen. The screenshot 700 in FIG. 7a illustrates that the menu item 122 has been selected and a corresponding drop-down menu 123 is displayed in the lower section 20 of the display screen. The drop-down menu 123 shows a list of submenu items B1, B2, B3, and B4 available within the menu item 122. The information corresponding to the selected menu item 122 is also displayed in the lower section 20 of the display screen. In this example, the information is overwritten in the part of the lower section 20 of the screen which is used to display the drop-down menu. In the screenshot of 700, the currently selected menu item 122 is highlighted to indicate that it is in an active state. The memory device 404 records the status of the selected menu item 122 as “active-2”.

When the user selects a submenu item, for example B2 which is a third level node, the drop-down menu 123 disappears, and the screen layout is updated with the screenshot of 700a. Referring to screenshot 700a, the menu item 122 has been relabelled as 121 to indicate that it is now in an inactive state. Notably, the menu items 111 and 121 remain in the same position. The menu item 131 in screenshot 700 has now been replaced by menu item 152 which is also a third level node. The border of the menu item 152 is highlighted to indicate that this menu item is in its active state. The memory device 404 records the status of the selected menu item 152 as “active-1”. The information corresponding to the currently selected menu item is displayed in the lower section 50 of the screen.

The example of FIG. 7b demonstrates that the apparatus of the invention can be configured to display the menu items as a sequential selection history list containing previously selected menu items and the currently selected menu item.

In the screenshot of 701, the menu items 111, 122, 131 are located in the upper section of the screen. The screenshot 701 in FIG. 7b illustrates that the menu item 122 has been selected and a corresponding drop-down menu 123 is displayed in the lower section 20 of the display screen. The drop-down menu 123 shows a list of submenu items B1, B2, B3, and B4 available within the menu item 122. The information corresponding to the selected menu item 122 is also displayed in the lower section 20 of the display screen. In this example, the information is overwritten in the part of the lower section 20 of the screen which is used to display the drop-down menu. In the screenshot of 701, the currently selected menu item 122 is highlighted to indicate that it is in an active state. The memory device 404 records the status of the selected menu item 122 as “active-2”.

When the user selects a submenu item, for example B2, the drop-down menu 123 disappears, and the screen layout is updated with the screenshot of 701a. Referring to screenshot 701a, the menu item 122 has been relabelled as 121 to indicate that it is now in an inactive state. The menu items have moved in the left direction such that the most recently selected menu item 152 is now displayed in the rightmost box of the history list. The menu item 111 has disappeared from the history list in screenshot 701a. The menu item 121 has moved to the previous position of menu item 111, and the menu item 131 has moved to the previous position of menu item 121. Thus, the history list in this example represents a true sequential selection history. A menu item scroll feature, such as a scroll bar (not shown) can be implemented to allow the user to scroll through the menu items in order to display the menu item 111 on the screen.

The border of the menu item 152 is highlighted to indicate that this menu item is in its active state. The memory device 404 records the status of the selected menu item 152 as “active-1”. The information corresponding to the currently selected menu item is displayed in the lower section 50 of the screen.

The example of FIG. 7c again demonstrates that the apparatus of the invention can be configured to display the menu items as a history list containing the top level node (selected menu item 112), the second level node (selected menu item 121), and the third level node (menu item 131) of a hierarchical information structure.

In the screenshot of 702, the menu items 112, 121, 131 are located in the upper section of the screen. The screenshot 702 in FIG. 7c illustrates that the menu item 112 has been selected and a corresponding drop-down menu 113 is displayed in the lower section 10 of the display screen. The drop-down menu 113 shows a list of submenu items A1, A2, A3, and A4 available within the menu item 112. The information corresponding to the selected menu item 112 is also displayed in the lower section 10 of the display screen. In this example, the information is overwritten in the part of the lower section 10 of the screen which is used to display the drop-down menu. In the screenshot of 702, the currently selected menu item 112 is highlighted to indicate that it is in an active state. The memory device 404 records the status of the selected menu item 112 as “active-2”.

When the user selects a submenu item, for example A4 which is a second level node, the drop-down menu 113 disappears, and the screen layout is updated with the screenshot of 702a. Referring to screenshot 702a, the menu item 112 has been relabelled as 111 to indicate that it is now in an inactive state. The menu items 121 and 131 have disappeared from the history list, and have been replaced by a newly selected menu item 126 which is a second level node. The border of the menu item 126 is highlighted to indicate that this menu item is in its active state. The memory device 404 records the status of the selected menu item 126 as “active-1”. The information corresponding to the currently selected menu item is displayed in the lower section 26 of the screen.

Although specific embodiments of the invention have been described, further modifications are also possible. In particular, it will be apparent to those skilled in the art that various changes can be made to the preferred embodiments without departing from the scope of the invention.

1. A method of displaying information, the method comprising:
displaying selectable menu items in a first display region, wherein each of said selectable menu items has a status that can be switched between an active state and an inactive state, said selectable menu items correspond to information available in an information source, and the status of at least a selected menu item is recordable;
in response to receiving a first selection of one of said selectable menu items, retrieving information corresponding to the currently selected menu item, and recording said status of the currently selected menu item as a first active state;
displaying the retrieved information in a second display region;
in response to receiving a second selection of said selected menu item, displaying a submenu of said selected menu item in said second display region, and recording said status of the currently selected menu item as a second active state; and
receiving a third selection of one of said selectable menu items, wherein a submenu or information is displayed in response to said third selection in dependence upon said status of a previously selected menu item.

2. A method according to claim 1, further comprising removing said submenu from said second display region, if said third selection is made of said previously selected menu item and said status of said previously selected menu item is said second active state.

3. A method according to claim 1, further comprising displaying a submenu of the currently selected menu item in said second display region, if said third selection is made of an inactive selectable menu item and said status of said previously selected menu item is said second active state.

4. A method according to claim 3, further comprising removing said submenu of the previously selected menu item from said second display area.

5. A method according to claim 1, further comprising receiving a selection of a submenu item of said submenu, and in response to said selection of the submenu item displaying information corresponding to said selected submenu item in said second display region.

6. A method according to claim 5, further comprising removing said submenu from said second display region, and displaying a further selectable menu item in said first display area, wherein said further selectable menu item corresponds to said displayed information.

7. A method according to claim 6, further comprising recording said status of said further selectable menu item as said first active state.

8. A method according to claim 1, wherein displaying selectable menu items includes displaying history menu items relating to previously received user selections of said selectable menu items and the currently selected menu item in said first display region.

9. A method according to claim 8, wherein said previously received user selections of said selectable menu items correspond to navigation down levels of a hierarchy of the information.

10. A method according to claim 1, wherein displaying selectable menu items includes replacing at least one of said selectable menu items with the currently selected menu item.

11. A method according to claim 5, wherein said first selection, second selection, third selection, and the selection of the submenu item are of the same selection type.

12. A method of displaying information, the method comprising:
displaying selectable menu items in a first display region, wherein said selectable menu items correspond to information available in an information source;
in response to receiving a first selection of one of said selectable menu items, retrieving information corresponding to the currently selected menu item;
displaying the retrieved information in a second display region; and
in response to receiving a second selection of said selected menu item, displaying a submenu of said selected menu item in said second display region,
wherein said first selection and said second selection are of the same selection type.

13. A method according to claim 12, further comprising removing said submenu from said second display region, in response to receiving a third selection of said selected menu item.

14. A method according to claim 12, further comprising receiving a third selection of an unselected menu item, and in response to said third selection, displaying a submenu of the currently selected menu item in said second display region.

15. A method according to claim 14, further comprising removing said submenu of the previously selected menu item from said second display area.

16. A method according to claim 12, further comprising receiving a selection of a submenu item of said submenu, and in response to said selection of the submenu item displaying information corresponding to said selected submenu item in said second display region.

17. A method according to claim 16, further comprising removing said submenu from said second display region, and displaying a further selectable menu item in said first display area, wherein said further selectable menu item corresponds to said displayed information.

18. A method according to claim 12, wherein displaying selectable menu items includes displaying history menu items relating to previously received user selections of said selectable menu items and the currently selected menu item in said first display region.

19. A method according to claim 18, wherein said previously received user selections of said selectable menu items correspond to navigation down levels of a hierarchy of the information.

20. A method according to claim 12, wherein displaying selectable menu items includes replacing at least one of said selectable menu items with the currently selected menu item.

21. A method according to claim 16, wherein said first selection, second selection, third selection, and the selection of the submenu item are of the same selection type.

22. Apparatus for displaying information, the apparatus comprising:
a status recording means for recording a status of at least one selected menu item;
a user input device for receiving user selections; and
a controller configured to:
control a display device to display selectable menu items in a first display region, each of said selectable menu items having a status that can be switched between an active state and an inactive state, and wherein said selectable menu items correspond to information available in an information store;
retrieve information in response to a first selection of one of said selectable menu items, said retrieved information corresponds to the currently selected menu item,
control said display device to display said retrieved information in a second display region, switch said status of the currently selected menu item to a first active state, and control said status recording means to record said status of the currently selected menu item as said first active state,
control said display device to display a submenu of said selected menu item in said second display region in response to receiving a second selection of said selected menu item, switch said status of the currently selected menu item to a second active state, and control said status recording means to record said status of the currently selected menu item as said second active state;
wherein said user input device is configured to receive a third selection of one of said selectable menu items, and said controller is configured to control said display device to display a submenu or information in response to said third selection in dependence upon said status of a previously selected menu item.

23. Apparatus according to claim 22, wherein said controller is further configured to remove said submenu from said second display region, if said third selection is made on said previously selected menu item and said status of said previously selected menu item is said second active state.

24. Apparatus according to claim 22, wherein said controller is further configured to control said display device to display a submenu of the currently selected menu item, if said third selection is made on an inactive selectable menu item and said status of said previously selected menu item is said second active state.

25. Apparatus according to claim 24, wherein said controller is configured to control said display device to remove said submenu of the previously selected menu item from said second display area.

26. Apparatus according to claim 22, wherein said user input device is configured to receive a selection of a submenu item of said submenu, and in response to said selection of said submenu item said controller is configured to control said display device to display information corresponding to said selected submenu item in said second display region.

27. Apparatus according to claim 26, wherein said controller is configured to control said display device to remove said submenu from said second display region, and to display a further selectable menu item in said first display area, wherein said further selectable menu item corresponds to said displayed information.

28. Apparatus according to claim 27, wherein said controller is configured to control said status recording means to record said status of said further selectable menu item as said first active state.

29. Apparatus according to claim 22, wherein said controller is configured to control said display device to display selectable menu items including history menu items relating to previously received user selections of said selectable menu items and the currently selected menu item in said first display region.

30. Apparatus according to claim 29, wherein said previously received user selections of said selectable menu items correspond to navigation down levels of a hierarchy of the information.

31. Apparatus according to claim 22, wherein said controller is configured to control said display device to replace at least one of said selectable menu items with the currently selected menu item.

32. Apparatus according to claim 22, wherein said first selection, second selection, third selection, and the selection of the submenu item are of the same selection type.

33. Apparatus for displaying information, the apparatus comprising:
a user input device for receiving user selections;
a controller configured to:
control a display device to display selectable menu items in a first display region, wherein said selectable menu items correspond to information available in an information store;
retrieve information in response to a first selection of one of said selectable menu items, said retrieved information corresponds to the currently selected menu item,
control said display device to display said retrieved information in a second display region, and
control said display device to display a submenu of said selected menu item in said second display region, in response to receiving a second selection of said selected menu item,
wherein said first selection and said second selection are of the same selection type.

34. Apparatus according to claim 33, wherein said user selection device is configured to receive a third selection of said selected menu item, and in response to said third selection, said controller is configured to control said display device to remove said submenu from said second display region.

35. Apparatus according to claim 33, wherein said user selection device is configured to receive a third selection of an unselected menu item, and in response to said third selection, said controller is configured to control said display device to display a submenu of the currently selected menu item in said second display region.

36. Apparatus according to claim 35, wherein said controller is configured to control said display device to remove said submenu of the previously selected menu item from said second display area.

37. Apparatus according to claim 33, wherein said user input device is configured to receive a selection of a submenu item of said submenu, and in response to said selection of the submenu item, said controller is configured to control said display device to display information corresponding to said selected submenu item in said second display region.

38. Apparatus according to claim 37, wherein said controller is configured to control said display device to remove said submenu from said second display region, and to display further selectable menu item in said first display region, wherein said further selectable menu item corresponds to said displayed information.

39. Apparatus according to claim 33, wherein said controller is configured control said display device to display selectable menu items including history menu items relating to previously received user selections of said selectable menu items and the currently selected menu item in said first display region.

40. Apparatus according to claim 39, wherein said previously received user selections of said selectable menu items correspond to navigation down levels of a hierarchy of the information.

41. Apparatus according to claim 33, wherein said controller is configured to control said display device to replace at least one of said selectable menu items with the currently selected menu item.

42. Apparatus according to claim 37, wherein said first selection, second selection, third selection, and the selection of the submenu item are of the same selection type.

43. Apparatus for displaying information, the apparatus comprising:
display means for displaying selectable menu items and information corresponding to selected menu items status recording means for recording the status of at least one selected menu item;
user input means for receiving user selections;
control means configured to:
control said display means to display said selectable menu items in a first display region, each of said selectable menu items having a status that can be switched between an active state and an inactive state, and wherein said selectable menu items correspond to information available in storage means;
retrieve information in response to a first selection of one of said selectable menu items, said retrieved information corresponds to the currently selected menu item,
control said display means to display said retrieved information in a second display region, switch said status of the currently selected menu item to a first active state, and control said status recording means to record said status of the currently selected menu item said a first active state, and
control said display means to display a submenu of said selected menu item in said second display region in response to receiving a second selection of said selected menu item, switch said status of the currently selected menu item to a second active state, and control said status recording means to record said status of the currently selected menu item as said second active state;
wherein said user input means is configured to receive a third selection of one of said selectable menu items, and said control means is operable to display a submenu or information in response to said third selection in dependence upon said status of a previously selected menu item.

44. Apparatus for displaying information, the apparatus comprising:
display means for displaying selectable menu items and information corresponding to selected menu items;
user input means for receiving user selections;
control means configured to:
control said display means to display selectable menu items in a first display region, and wherein said selectable menu items correspond to information available in storage means;
retrieve information in response to a first selection of one of said selectable menu items, said retrieved information corresponds to the currently selected menu item,
control said display means to display said retrieved information in a second display region,
control said display means to display a submenu of said selected menu item in said second display region, in response to receiving a second selection of said selected menu item, and
wherein said first selection and said second selection are of the same selection type.

45. A handheld device comprising the apparatus claimed in any one of claims 22, 33, 43 and 44.

46. A recoding medium carrying code for configuring a programmable apparatus to perform the method of any one of claims 1 and 12.
